(19) United States
(12) Patent Application Publication
(10) Pub. No.: US 2002/0007707 A1
(43) Pub. Date: Jan. 24, 2002

(54) Slitter apparatus and method of providing and maintaining a predetermined pass line

(76) Inventors: Harold R. Braner, Palm Beach Gardens, FL (US); Tadeusz Marecki, Chicago, IL (US)

Correspondence Address: LAW OFFICES OF DICK AND HARRIS, Suite 3800, 181 West Madison Street, Chicago, IL, 60602, US

(21) Appl. No.: 09/859,921

(22) Filed: May 17, 2001

Related U.S. Application Data
(63) Continuation of application No. 09/108,058, filed on Jun. 30, 1998, now abandoned.

(51) Int. Cl. B26D 1/15

(52) U.S. Cl. 83/13; 83/436.1; 83/503

(57) ABSTRACT

A slitter apparatus for the slitting of substantially flat articles, such as unrolled steel, comprising paired entry and exit pinch rollers and paired slitter knives. The vertical positions of the paired pinch rollers and slitter knives are coordinated whereby the path of travel, i.e. pass line, of the steel through the slitter is predetermined to a substantially optimum path for slitting of the steel. The invention likewise includes a method of determining and positioning the slitter in accordance with a substantially optimum path of travel for such articles being slit.

### BACKGROUND OF THE INVENTION

1. Field of the Invention

The invention is directed to slitting systems, and more particularly a system for slitting rigid, substantially flat objects, such as steel strips.

2. Background Art

The processing of steel coils from large, heavy rolls into elongated strips which are then slit and rewound into smaller and lighter coils is well known in the art. These steel coils often weigh hundreds, and even thousands of pounds each and are difficult to handle due not only to the shear weight of the material but the rigidity of the steel.

Accordingly, the rolls are unwound and processed through a slitter which cuts the steel into multiple longitudinal strips which can then be separated and rewound into smaller more manageable coils for further processing, transportation or storage. One method for slitting the steel into longitudinal strips is to run the steel through one or more pairs of circular slitter knives which rotate as the steel passes between the two knives.

When using the method of paired slitter knives it is important to determine and maintain a particular line of travel for the steel so as to minimize the wear and tear on the paired slitter knives. This line of travel should be based upon not only the gauge of the steel but also the diameter of the blades which changes with each use of the knives. As it should be recognized, if the path of the steel not be centered between the knives, the wear on one of the circular slitter knives will be greater than on the other of the paired slitter knives and thereby decrease the lifespan of any particular slitter knife. However, the position of the slitter knives is currently determined solely with regard to the gauge of the steel.

Therefore it is an object of the present invention to develop an apparatus and corresponding method for automatically determining and maintaining a particular predetermined path of travel for the steel material through the slitter knives based upon the gauge of the steel and the diameter of the slitter knives so as to minimize the wear and tear on such slitter knives and consequently the need for replacing such slitter knives.

It is further an object of the invention to lessen the burrs created on steel material being slit by the slitter knives.

### SUMMARY OF THE INVENTION

The invention comprises a slitter apparatus for the slicing of steel strips into longitudinal segments. The slitter apparatus comprises paired upper and lower substantially circular slitter knives having a predetermined diameter, paired upper and lower entry pinch rollers, which are positioned upstream from the slitter knives, paired upper and lower exit pinch rollers which are positioned downstream from the slitter knives, means for adjusting the vertical positions of the upper slitter knife, means for adjusting the vertical position of the lower entry pinch roller, means for adjusting the vertical position of the lower exit pinch roller, and means for coordinating the vertical adjustment means of the upper slitter knife, lower entry pinch roller and lower exit pinch roller. The paired upper and lower entry pinch rollers are positioned upstream from the slitter knives so that the upper entry pinch roller is directly above the lower entry pinch roller with each entry pinch roller being capable of independent vertical movement. Similarly, the upper and lower exit pinch rollers are positioned downstream from the at least one slitter knife so that the upper exit pinch roller is positioned directly above the lower exit pinch roller and each exit pinch roller is capable of independent vertical movement.

The upper slitter knife is adjusted vertically so that the space between the upper and lower slitter knife is slightly less than the thickness of the steel strip being slit. Accordingly, the upper and lower slitter knives each penetrate the steel towards slitting same. The lower entry pinch roller is adjusted so that it is positioned relative to the upper pinch roller so that the distance between the two rollers is substantially equal to the thickness of the steel material passing through them to, in turn, help drive the material through the slitter knives. Likewise, the lower exit pinch roller is positioned vertically so that the distance between the exit pinch rollers is substantially proximate to the thickness of the material being received between the rollers.

The slitter knives and pinch rollers are all vertically positioned in accordance with a particular line of travel the steel should take through the slitter apparatus in order to achieve substantially optimum performance from the slitter. The line of travel is determined by accounting for the type of steel being slit, the thickness of the steel being slit, the diameter of the knives and the intended penetration of the knives into the steel.

The coordinating means is used to coordinate the vertical adjustments of the lower entry pinch roller and lower exit pinch roller so as to position said lower entry pinch roller and exit pinch roller in accordance with a particular predetermined line of travel of said steel strip. Similarly the vertical adjustment of the upper slitter knife is coordinated with the vertical position of the lower entry and exit pinch rollers towards providing and maintaining the optimum line of travel of the steel through the apparatus. The coordination of the upper slitter knife and the lower entry and exit pinch rollers is controlled by a controlling means.

The invention further includes a method for slitting a steel strip of material. The method comprises the steps of: (a) determining a substantially optimum line of travel for said steel strip through a slitter apparatus having upper and lower entry pinch rollers, upper and lower substantially circular slitter knives and upper and lower exit pinch rollers, which line of travel is determined by accounting for steel type, steel thickness, diameter of said slitter knives and intended penetration of said slitter knives into said steel strip; (b) adjusting said lower entry and exit pinch rollers' vertical position in accordance with said substantially optimum line of travel so that said lower entry and exit pinch rollers and said lower slitter knife are substantially parallel to each other; (c) adjusting said upper slitter knife's vertical position in accordance with said substantially optimum line of travel of so that said upper slitter knife and said upper entry and exit pinch rollers are substantially parallel to each other; (d) coordinating said vertical adjustment of said upper slitter knife with said vertical adjustment of said lower entry and exit pinch rollers; and (e) engaging said vertical adjustment of said lower pinch rollers and said upper slitter knife in accordance with said predetermined substantially optimum line of travel for said steel.

### BRIEF DESCRIPTION OF THE DRAWINGS

FIG. 1 of the drawings is a side elevational view of the invention, showing in particular a steel strip as it travels between slitter knives;

FIG. 2 of the drawings is a close-up side elevational view of the invention;

FIG. 3 of the drawings is a close-up of the slitter knives of the invention, showing in particular the rotation of the pinch rollers and slitter knives as the steel strip travels between them.

### DETAILED DESCRIPTION OF THE DRAWINGS

While this invention is susceptible of embodiment in many different forms, there is shown in the drawings and will herein be described in detail, one specific embodiment with the understanding that the present disclosure can be considered as an exemplification of the principles of the invention and is not intended to limit the invention to the embodiment illustrated.

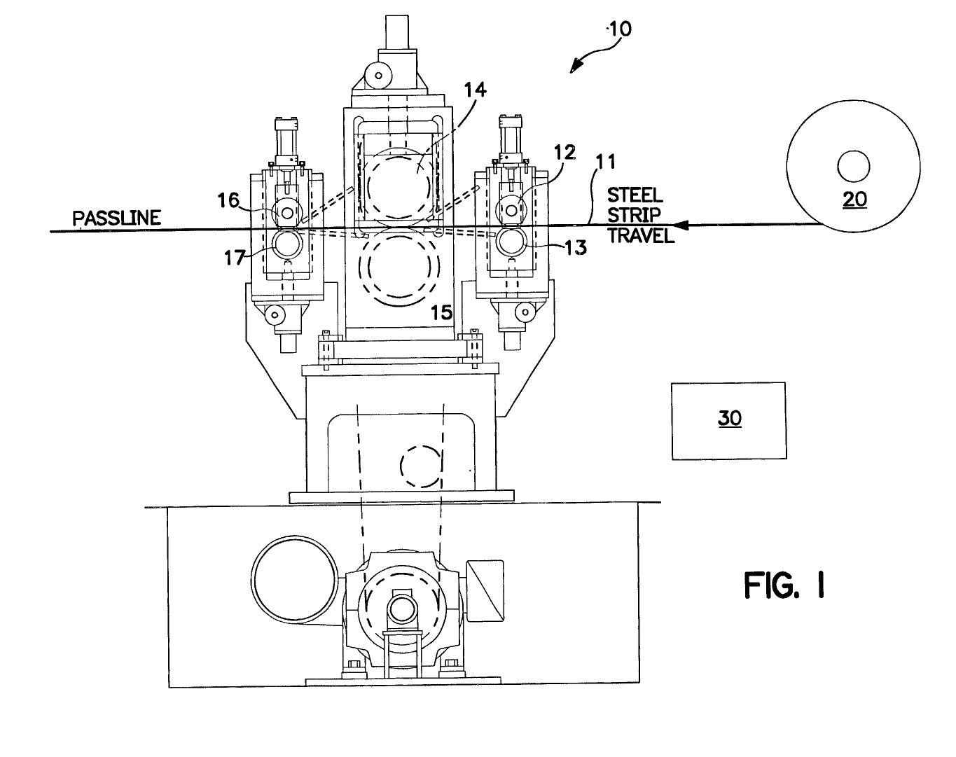

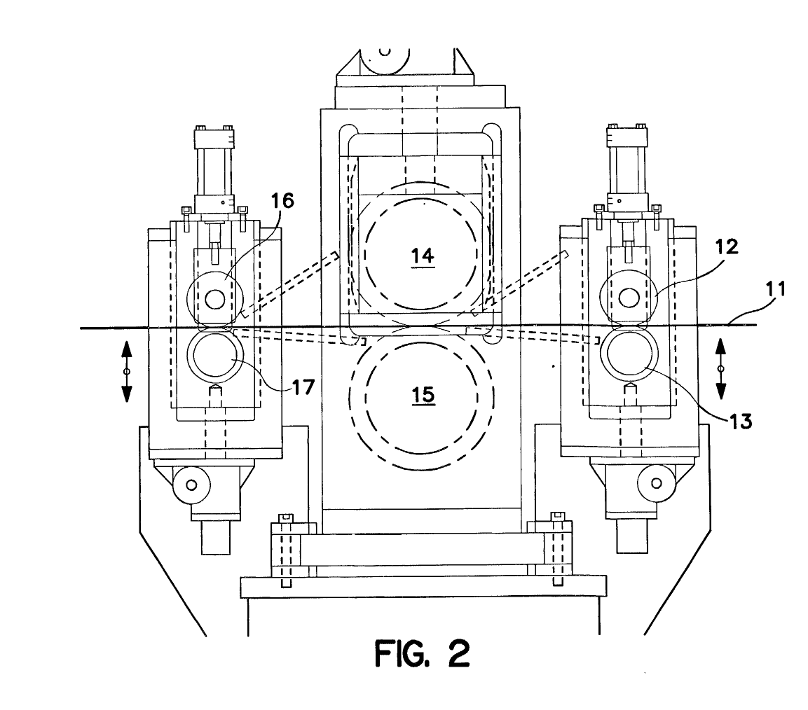

Slitter apparatus 10 is shown in FIGS. 1 through 3 and comprises upper entry pinch roller 12, lower entry pinch roller 13, upper slitter knife 14, lower slitter knife 15, upper exit pinch roller 16 and lower exit pinch roller 17, means 30 for determining the substantially optimum line of travel of the steel strip, means 30 for coordinating the vertical position of lower entry pinch roller 13, upper slitter knife 15, and lower exit pinch roller 17, means 30 for controlling the coordination of the vertical adjustments of the pinch rollers and slitter knife. Accordingly, steel from roll 20 enters apparatus 10 between entry pinch rollers 12 and 13 continues on between and through slitter knives 14 and 15 to exit pinch rollers 16 and 17 where it leaves apparatus 10 for either recoiling or further processing.

As shown in FIG. 1, steel is uncoiled from roll 20 and inserted into slitter apparatus 10. Pass line 11 is determined by means 30 so as to substantially optimize the cutting by slitter knives 14 and 15 while also minimizing the wear on the slitter knives. This pass line 11 is determined by taking into account not only the type of steel strip, the gauge or thickness of the steel strip but also the diameter of slitter knives 14 and 15 and the intended penetration of slitter knives 14 and 15 into the steel strip. Lower entry pinch roller 13 and lower exit pinch roller 17 are vertically positioned by means 30 so as to be located in accordance with pass line 11 of the steel strip. Similarly upper slitter knife 14 is positioned vertically by means 30 so as to be located in accordance with pass line 11.

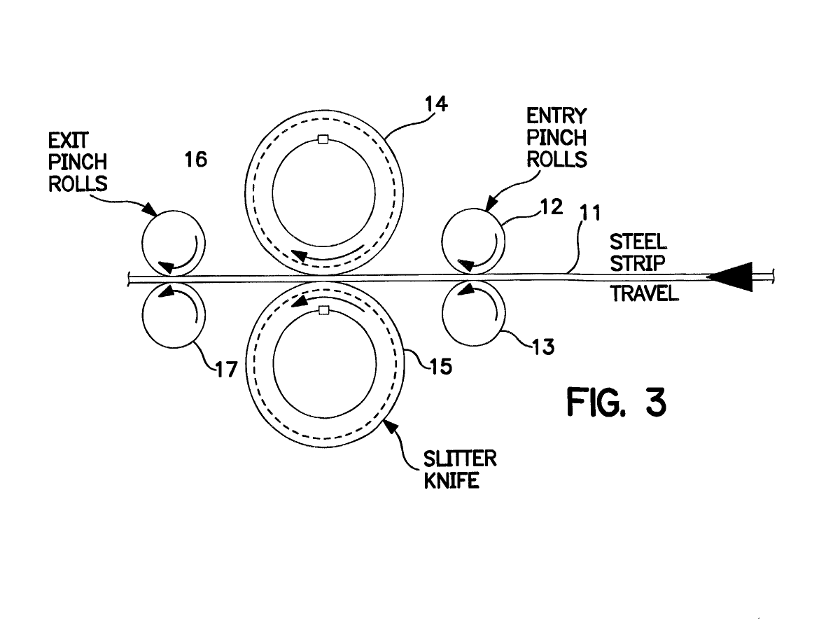

The vertical distance between upper entry pinch roller 12 and lower entry pinch roller 13 is substantially equal in width to the thickness of the steel to accommodate the unrolled steel without damage to either the steel or entry pinch rollers 12 and 13. Entry pinch rollers 12 and 13 may also be driven so as to rotate as shown in FIG. 3, to, in turn, assist in uncoiling the steel from roll 20. The vertical distance of exit pinch rollers 16 and 17 are adjusted in the same manner as entry pinch rollers 12 and 13. Exit pinch roller may also be driven so as to turn in the direction of the arrows shown in FIG. 3. thereby easing the steel along pass line 11 through slitter knives 14 and 15.

In contrast, the vertical distance between slitter knives 14 and 15 is slightly less than the thickness of the unrolled steel so that each of the knives actually slits the steel. It is preferable that the distance between slitter knives 14 and 15 is such that each knife only penetrates a portion of the way through the thickness of the unrolled steel and does not contact the other respective slitter knife. As with the entry pinch rollers, slitter knives 14 and 15 are usually driven as shown in FIG. 3, so as to not only ease the slitting process but to also at least partially propel the steel strip along pass line 11.

The vertical positions of entry pinch rollers 13, slitter knife 14 and exit pinch rollers 17 are all coordinated relative to each other by means 30 so that the upper entry and exit pinch rollers and the upper slitter knife are substantially parallel to each other and the lower entry and exit pinch rollers and the lower slitter knife are substantially parallel to each other to, in turn, provide and maintain a substantially optimum pass line of travel 11 for the steel from roll 20 through slitter apparatus 10 thereby minimizing the wear and tear on slitter knives 14 and 15.

The relative and coordinated positions of slitter knives 14 and 15 and pinch rollers 12, 13, 16 and 17, which are providing and maintaining pass line 11 are all controlled by means 30 which preferably include computer control systems activated by keystrokes. Accordingly, means 30 is included for coordinating the relative vertical positions of lower entry pinch roller 13, slitter knife 15, and exit pinch roller 17 to adjust predetermined pass line 11 as necessary as changes occur from roll to roll. The mechanism for vertically positioning the rollers and slitter knives are known in the art and may include hydraulic systems, compression springs, piston systems, hand or automated adjustable bolt or screw systems.

As will be further appreciated, depending on the dimension of the steel coming from roll 20, multiple pairs of rollers and slitter knives may be required to work in parallel within apparatus 10. It is contemplated that the invention described herein will work equally well and in the same manner with such multiple set of pairs as with a single set of paired of rollers and slitter knives. However, the operation of a set of single pairs have been described.

The foregoing description and drawings merely explain and illustrate the invention and the invention is not limited thereto, except insofar as the appended claims are so limited as those skilled in the art who have the disclosure before them will be able to make modifications and variations therein without departing from the scope of the invention.

1. A slitter apparatus for slicing steel strips into longitudinal segments, said slitter apparatus comprising:
paired upper and lower substantially circular slitter knives, said upper slitter knife being operably positioned directly above said lower slitter knife with said upper slitter knife being capable of vertical movement for slitting of said steel strips of varying thicknesses;
paired upper and lower entry pinch rollers positioned upstream from said at least one slitter knife, said upper entry pinch roller being operably positioned directly above said lower entry pinch roller with each said entry pinch rollers being capable of vertical movement for receipt and guidance of said steel strips of varying thicknesses;
paired upper and lower exit pinch rollers positioned downstream from said at least one slitter knife, wherein said upper exit pinch roller being operably positioned directly above said lower exit pinch roller with each of said exit pinch rollers being capable of vertical movement for receipt and guidance of said steel strips of varying thicknesses;
means for vertically adjusting said upper slitter knife towards said lower slitter knife so as to create a space between said upper and lower slitter knives slightly less than said thickness of said steel strip, to, in turn, permit said slitter knives to penetrate into said thickness of said steel towards slitting same;
means for vertically adjusting said upper and lower entry pinch rollers towards each other so as to create a space between said upper and lower entry pinch rollers substantially equal in width to said thickness of said steel strip;
means for vertically adjusting said upper and lower exit pinch rollers towards each other so as to create a space between said upper and lower exit pinch rollers substantially equal in width to said thickness of said steel strip;
means for determining a substantially optimum line of travel of said steel strip through said slitter apparatus by accounting for steel type, steel thickness, diameter of said slitter knives and intended penetration of said slitter knives into said steel strip;
means for coordinating said vertical adjustment means of said lower entry pinch roller and said vertical adjustment means of said lower exit pinch roller so as to operably position said lower entry and exit pinch rollers at a location substantially parallel to each other to, in turn, provide and maintain a substantially optimum line of travel for said steel strip through said apparatus;
means for coordinating said vertical adjustment means of said upper slitter knife with said vertical adjustment means of said lower entry pinch roller and said vertical adjustment means of said lower exit pinch roller, so as to operably position said lower slitter knife at a location substantially parallel to said lower entry and exit pinch rollers, and said upper slitter knife at a location substantially parallel to said upper entry and exit pinch rollers, to, in turn, provide and maintain a substantially optimum line of travel for said steel strip through said apparatus; and
means for controlling said coordinating means of said lower pinch rollers and said coordinating means of said upper slitter knife upon determination of said substantially optimum line of travel for said steel.

2. A method for slitting a steel strip comprising the steps of:
determining a substantially optimum line of travel for said steel strip through a slitter apparatus having upper and lower entry pinch rollers, upper and lower substantially circular slitter knives and upper and lower exit pinch rollers, which line of travel is determined by accounting for steel type, steel thickness, diameter of said slitter knives and intended penetration of said slitter knives into said steel strip;
adjusting said lower entry and exit pinch rollers' vertical position in accordance with said substantially optimum line of travel so that said lower entry and exit pinch rollers and said lower slitter knife are substantially parallel to each other;
adjusting said upper slitter knife's vertical position in accordance with said substantially optimum line of travel of so that said upper slitter knife and said upper entry and exit pinch rollers are substantially parallel to each other;
coordinating said vertical adjustment of said upper slitter knife with said vertical adjustment of said lower entry and exit pinch rollers; and
engaging said vertical adjustment of said lower pinch rollers and said upper slitter knife in accordance with said predetermined substantially optimum line of travel for said steel.
